(19) United States
(12) Patent Application Publication
(10) Pub. No.: US 2009/0179436 A1
(43) Pub. Date: Jul. 16, 2009

(54) POSITIVE ACTION LOCK FOR SLIDING WINDOWS

(76) Inventors: Albert Sagalara, Owatonna, MN (US); Clark Velzke, Medford, MN (US); Glen Wolf, Owatonna, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/268,294

(22) Filed: Nov. 10, 2008

Related U.S. Application Data
(60) Provisional application No. 60/986,872, filed on Nov. 9, 2007.

(51) Int. Cl. E05C 1/14; E05B 55/00

(52) U.S. Cl. 292/174; 49/449

(57) ABSTRACT

A sliding window system can be equipped with a latch or lock mechanism. The lock mechanism can include a lock base mounted on a sliding sash of a window assembly opposite a keeper. The latch bolt of lock mechanism can be received in the keeper to latch the sashes together. A trigger is operably coupled with the latch bolt. To open the window, the lock mechanism is disengaged from the keeper by grasping a pull handle and pulling outwardly away from the window. As a result, the bolt moves to a retracted position within the lock base and a portion of the trigger extends out of the lock base, with the window capable of movement into an open position. When closing the window, the trigger contacts the keeper, releasing the bolt under the bias of a spring into the keeper, thus locking the window.

### RELATED APPLICATION

The present application claims the benefit of U.S. Provisional Application No. 60/986,872, filed Nov. 9, 2007 and entitled “POSITIVE ACTION LOCK FOR SLIDING WINDOWS,” the disclosure of said application being hereby incorporated by reference in its entirety.

### FIELD OF THE INVENTION

The present invention relates to windows, and more specifically, to latching mechanisms for sliding windows.

### BACKGROUND OF THE INVENTION

Double hung and other sliding sash type windows are very common. Typically, a latch or locking mechanism is used to secure the sashes in place to inhibit unintentional opening of the sashes and unauthorized entry to the structure.

One very common mechanism used to lock sashes together is the so-called check rail lock, which includes a sweep cam attached to a rotatable handle. The check rail lock is mounted on one of the sashes, usually the lower sash of a double-hung window proximate the center of the sash rail. A keeper structure is mounted on the other sash proximate the check rail lock. As the handle is rotated in either direction, the sweep cam is rotated into or out of engagement with the keeper in order to enable locking or opening of the window as desired. These check rail lock devices are simple and relative easy to operate. A drawback of these devices, however, is that the handle can be rotated so that the sweep cam is extended even when the sash is open. When the sash is closed with the sweep cam in such position, the extended position of the sweep cam prevents full closure of the sash. The operator of the window may not notice the window is not fully closed and latched. In addition, the sweep cam may strike and damage the other sash. One example of a check rail lock type mechanism is disclosed in U.S. Pat. No. 6,478,347.

Another prior mechanism includes a sliding latch bolt that may be mounted on one sash and that is selectively engageable with a keeper mounted on the other sash. A drawback with these mechanisms, however, is often that the bolt must be held in a retracted position as the window is operated. In other cases where a mechanism for holding the bolt in a retracted position is employed, the bolt either releases as soon as the window is raised or must be manually released with a separate catch or button. In such cases, the window may fail to close fully and may not be noticed by the operator of the window. In addition, such bolt systems are relatively complex, requiring an undesirable number of components, which in turn increases manufacturing costs and the size of the assembly, and limits the window systems capable of employing these locks.

### SUMMARY OF THE INVENTION

A sliding window can be equipped with a latch or lock mechanism. The lock mechanism can include a lock housing mounted on a sliding sash of a window assembly opposite a keeper. The bolt of lock mechanism can be received in the keeper to latch the sashes together. To open the window, the lock mechanism is disengaged from the keeper by grasping a finger pull on a handle and pulling outwardly away from window. The latch handle slides outwardly and pulls the bolt out of the keeper. With the bolt in this position, the sash may be slid upwardly to open the window. When the lock mechanism is unlocked, a portion of a trigger shifts from a position within the lock base to a forward position projecting from the lock base. To close the window, the sash is slid downward. The keeper contacts the trigger, releasing the bolt. A biasing spring urges the bolt forwardly so that it is once again engaged in the keeper and the sashes are latched together as before.

A lock mechanism for a sliding window includes a lock housing and a keeper. Lock housing includes a lock base defining an opening or channel therein, a trigger slidably disposed in the base and operably coupled with a bolt. The bolt is selectively positionable between an extended position wherein a portion of the bolt extends outwardly from the housing through the opening and a retracted position wherein the bolt is contained in the housing. A biasing element is operably coupled to the bolt and arranged to bias the bolt toward the extended position. The trigger can comprise a single part movable within housing between a first position wherein a portion of the trigger extends outwardly from the housing and a second position wherein at least a portion of the trigger retreats back into and is contained in the housing. When the extended trigger comes into contact with the keeper, the trigger releases the bolt so it can engage the keeper, which locks the lock housing to the keeper. The lock mechanism can be released by pulling back on a handle disposed on a cover of lock base.

The disclosed interlinking of the trigger and bolt provides a lock mechanism with relatively few components. As such, the lock mechanism provides increased reliability and allows for the use of relatively small lock housings compared to conventional hardware. The availability of smaller lock housings to contain the components of the lock mechanism means that the lock mechanism can be employed on various window configurations, including vertical and horizontal window orientations. As such, the lock mechanism can be used with top mount, recessed mount, and face mount window systems.

### BRIEF DESCRIPTION OF THE DRAWINGS

FIG. 1 is an exploded view of a lock base, bolt and trigger of a lock mechanism according to the present disclosure;

FIG. 2 is an exploded view of a lock mechanism adapted for a top mounted window system according to the present disclosure;

FIG. 3 is an exploded view of a lock mechanism adapted for a recess mounted window system according to the present disclosure;

FIG. 4 is an exploded view of an unlocked lock mechanism according to the present disclosure;

FIG. 5 is a perspective view of an unlocked lock mechanism prior to disengagement with a keeper according to the present disclosure;

FIG. 6 is an exploded view of a lock mechanism in a locked position prior to triggering according to the present disclosure;

FIG. 7 is a perspective view of a locked lock mechanism according to the present disclosure;

FIG. 8 is an exploded view of a cover housing of a lock mechanism according to the present disclosure;

FIG. 9 is a perspective view of a handle pull of a lock mechanism according to the present disclosure;

FIG. 10 is a front view of a handle pull of a lock mechanism according to the present disclosure;

FIG. 11 is a bottom view of a cover of a lock mechanism according to the present disclosure;

FIG. 12 is a front view of a trigger of a lock mechanism according to the present disclosure;

FIG. 13 is a front view of a bolt of a lock mechanism according to the present disclosure;

FIG. 14 is a top view of a lock mechanism denoting cross-section view 18-18 according to the present disclosure;

FIG. 15 is a top view of a lock mechanism denoting cross-section view 19-19 according to the present disclosure;

FIG. 16 is a top view of a lock mechanism denoting cross-section view 20-20 according to the present disclosure;

FIG. 17 is a top view of a lock mechanism denoting cross-section view 21-21 according to the present disclosure;

FIG. 18 is a cross-section view of a lock mechanism in a trigger position according to the present disclosure;

FIG. 19 is a cross-section view of a lock mechanism in an engaged lock position according to the present disclosure;

FIG. 20 is a cross-section view of a lock mechanism in an unengaged unlocked position according to the present disclosure;

FIG. 21 is a cross-section view of a lock mechanism in an unengaged unlocked position according to the present disclosure;

FIG. 22 is a top view of a lock base, bolt and trigger of a lock mechanism, without a cover housing, denoting cross-section views 23-23 and 24-24 according to the present disclosure;

FIG. 23 is a cross-section view of a lock base, bolt and trigger of a lock mechanism according to the present disclosure;

FIG. 24 is a cross-section view of a lock base, bolt and trigger of a lock mechanism according to the present disclosure;

FIG. 25 is an exploded view of a lock mechanism according to the present disclosure;

FIG. 26 is an exploded view of a lock mechanism in an unlocked position according to the present disclosure;

FIG. 27 is a perspective view of a lock mechanism in a locked position according to the present disclosure;

FIG. 28 is an exploded view of a lock mechanism according to the present disclosure;

FIG. 29 is a perspective view of a keeper of a lock mechanism according to the present disclosure; and

FIG. 30 is a perspective view of a window system including a lock mechanism according to the present disclosure.

### DETAILED DESCRIPTION OF THE INVENTION

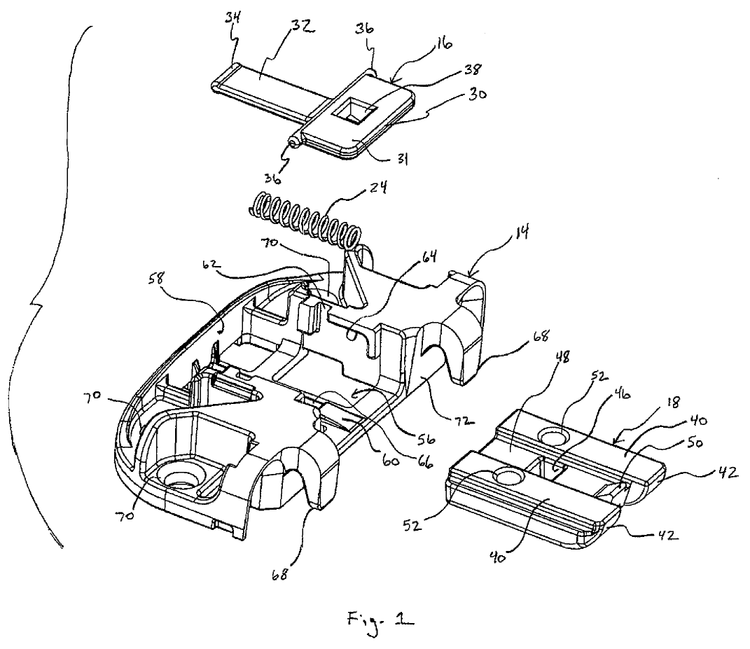

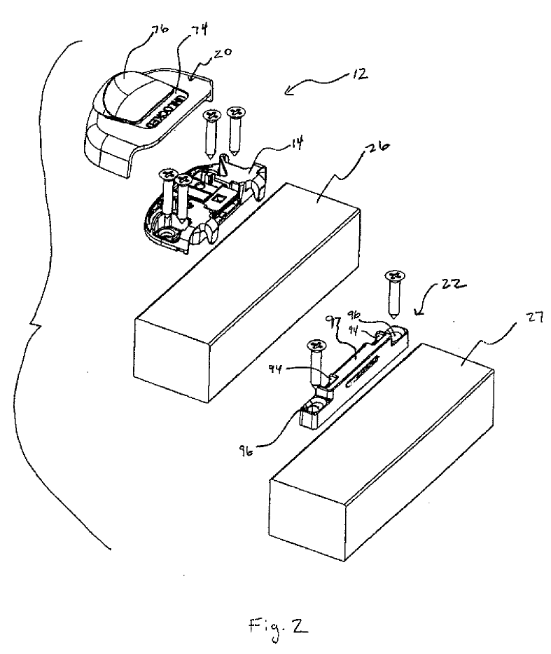

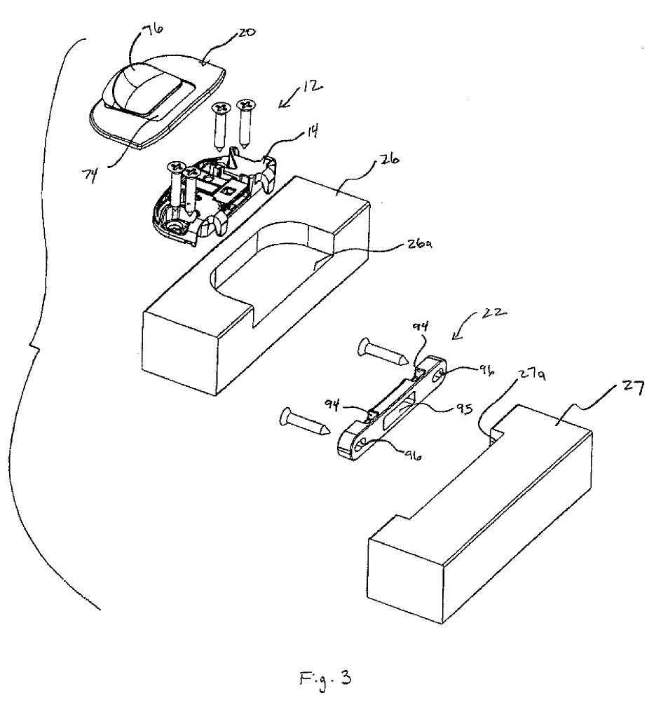

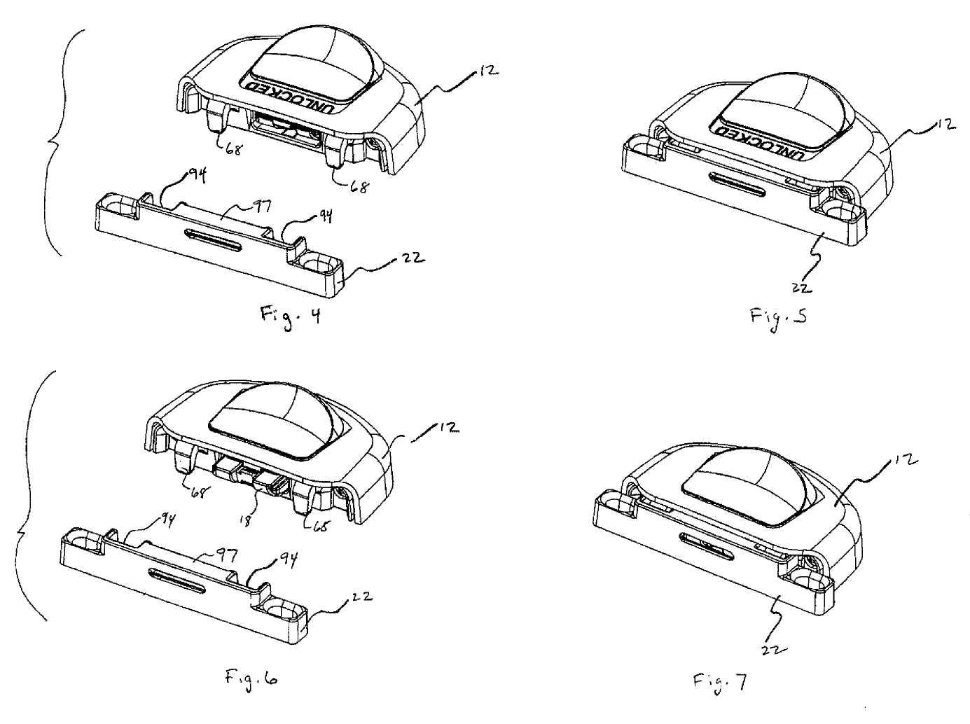

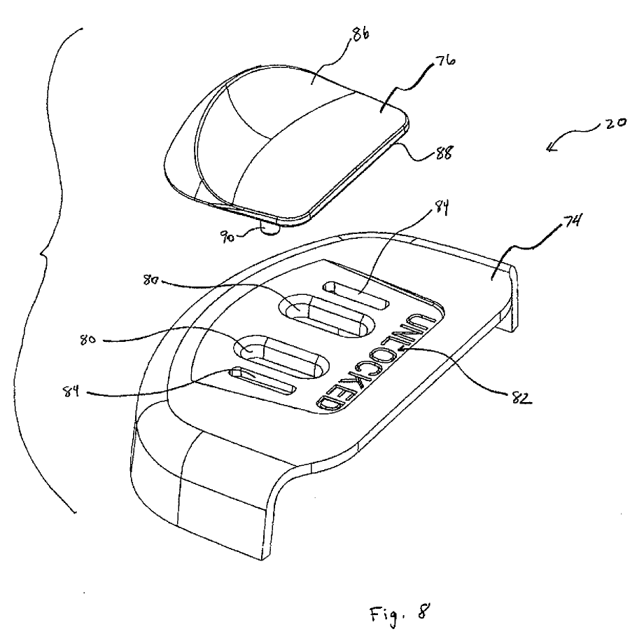

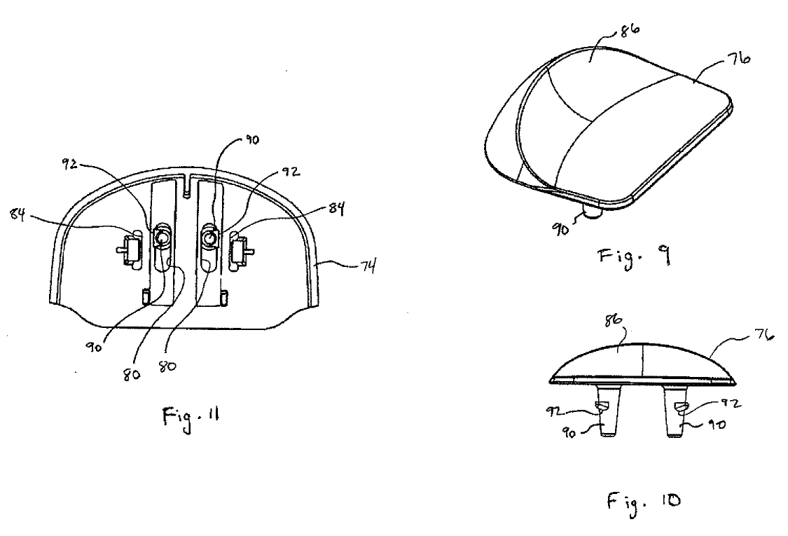

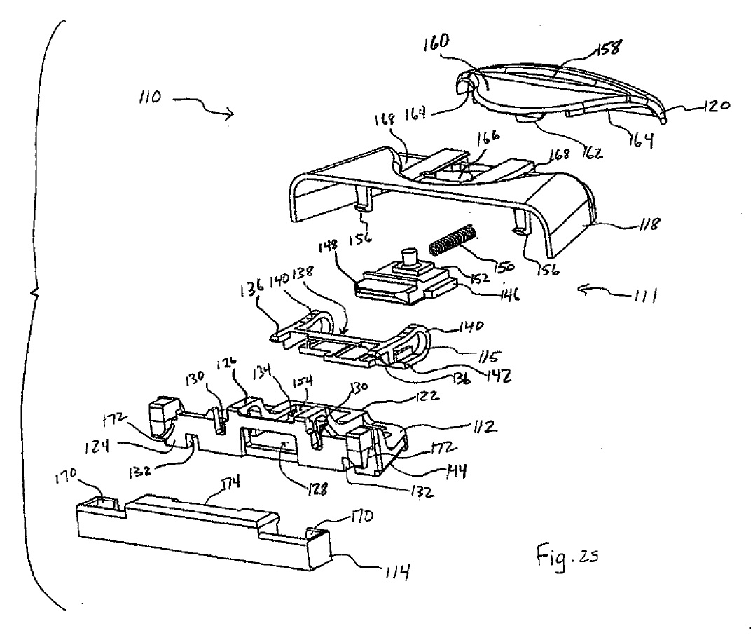

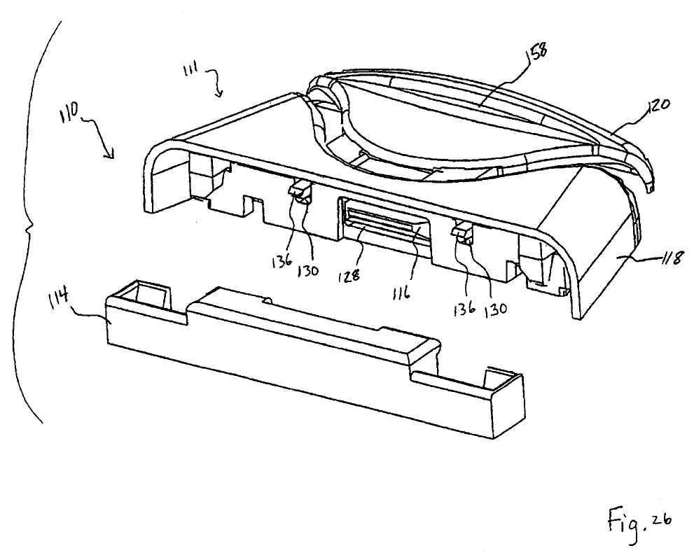

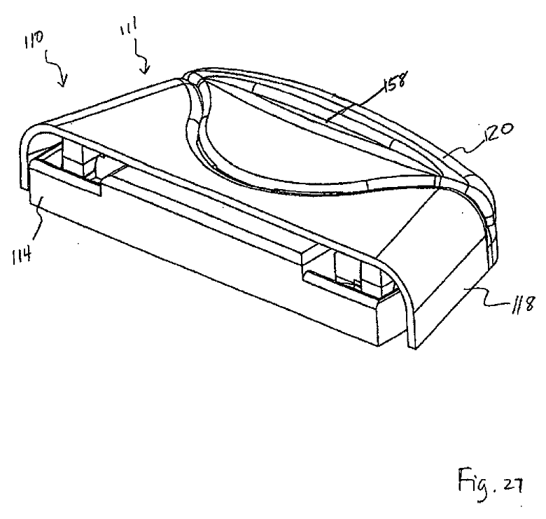

In one embodiment, as depicted in FIGS. 1-24, lock and latch mechanism 10 generally includes a lock housing 12 and a keeper 22. Lock housing 12 includes a lock base 14, trigger 16, latch bolt 18, and cover 20. Lock housing 12 can be disposed along a portion of a sliding window sash 26, while keeper 22 can be disposed along a portion of other sash 27, as shown in FIG. 30. As depicted in FIGS. 2-3, the lock mechanisms disclosed herein can be employed on recessed and top mounting window systems.

Referring generally to the embodiment of FIGS. 1-24, trigger 16 can include a front end portion 30, head portion 31, tail portion 32, tail bulb 34, pivots 36, trigger recess 38 and trigger catch 39. Front end portion 30 provides an engagement or triggering surface that allows lock mechanism 10 to lock even in situations where window sashes are misaligned. Pivots 36 can be rounded at least at their respective ends and extend out a distance laterally from the rear of the head portion 31. Further, tail portion 32 is generally elongate and narrower than head portion 31, with tail bulb 34 defining a rounded end for trail portion 32. Trigger recess 38 is defined in the top of head portion 31 and forms a corresponding trigger catch 39 (FIG. 12) at the bottom of trigger 16. Trigger 16 can be constructed of relatively flexible materials, such as plastics, metals and other like materials.

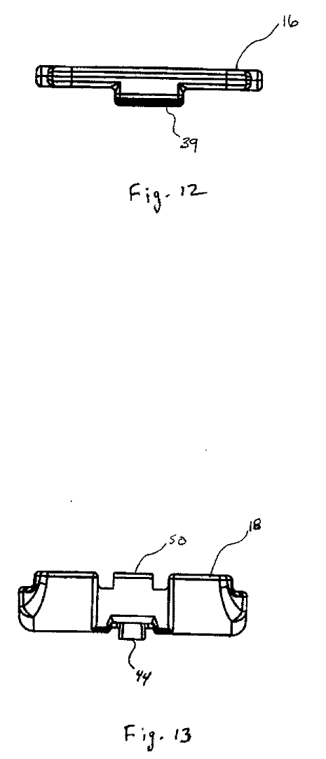

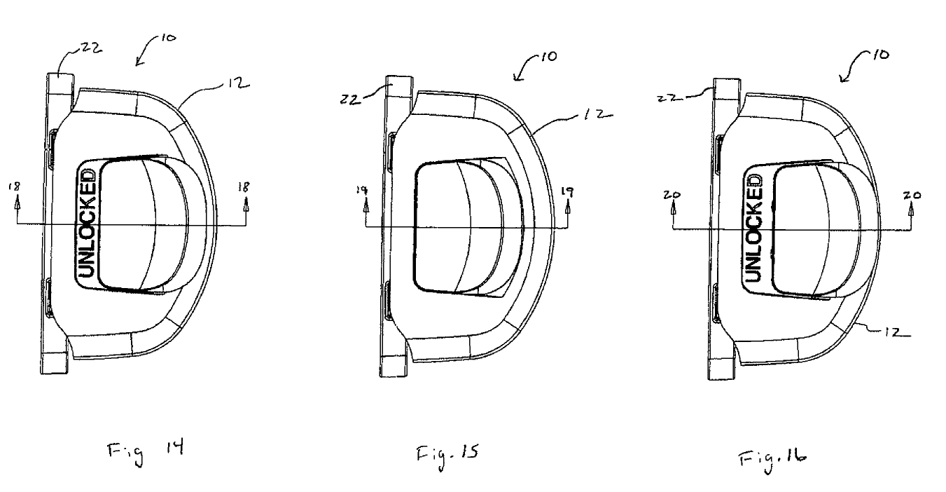

Latch bolt 18 can include sides 40, front end portion 42, stop 44, recess 46, center groove 48, catch 50, and pull apertures 52. Center groove 48 is flanked by sides 40 to define a recessed area adapted to receive tail portion 32 and catch 39 of trigger 16. As such, trigger 16 is slidably disposable within and along center groove 48. Forward advancement of trigger 16 within center groove 48 is limited by the abutment of catch 39 of trigger 16 with catch 50 (FIG. 13) of bolt 18. Sides 40 of bolt 18 can include rounded leading edges. Bolt 18 can be constructed of a variety materials, including plastics, metals, and other known materials.

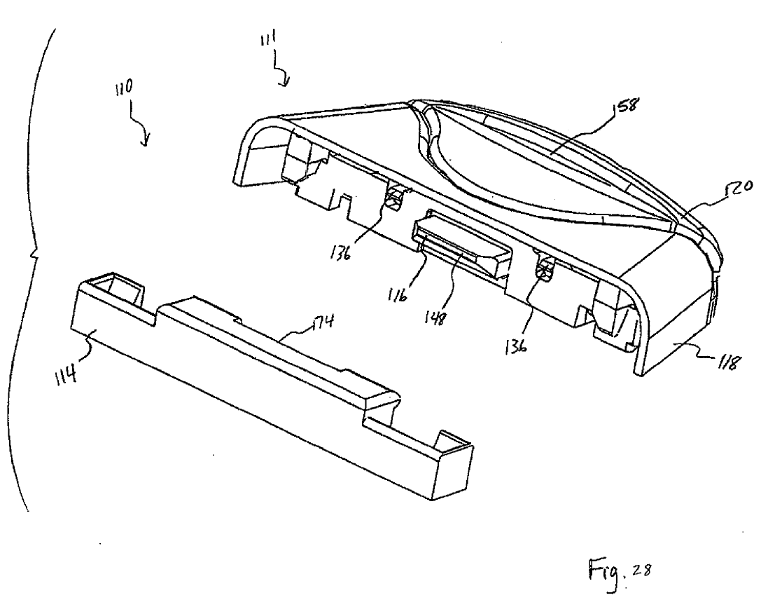

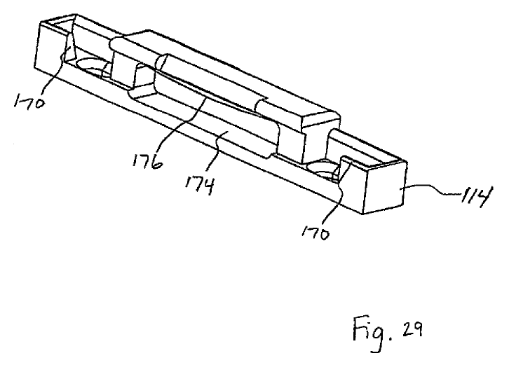

Lock base 14 generally includes lock channel 56, rear wall 58, lock base stop 60, pivot openings 62, base guides 64, spring groove 66, hooks 68, fastening apertures 70, and front wall 72. Lock channel 56 is adapted to receive trigger 16 and bolt 18, with bolt 18 slidably disposable along the base of the channel 56. A biasing element or spring 24 is operatively disposed in spring groove 66 between rear wall 58 and the rear of bolt 18 to bias bolt 18 outwardly through lock channel 56. Accordingly, bolt stop 44 rides along spring groove 66 such that forward advancement of bolt 18 within the channel 56 is limited by the abutment of bolt stop 44 with lock base stop 60. Trigger 16 is likewise positioned within lock channel 56 when trigger 16 is operably coupled with bolt 18. Trigger pivots 36 are slidably disposable along base guide 64 and provide a level pivotability for trigger 16 within lock base 14, as shown in FIGS. 23-24. Hooks 68 extend out from lock base 14 to facilitate securement and alignment of lock housing 12 with keeper 22.

Housing cover 20 generally includes cover plate 74 and pull 76, as shown in FIGS. 8-10. Cover plate 74 is adapted to cover and couple with lock base 14 by way of retention apertures 84. Cover plate 74 further includes pull grooves 80 and lock indicia 82. Pull 76 includes a handle grip or lip 86, front end portion 88 and posts 90. Posts 90 are inserted into pull grooves 80 and extend into lock base 14 for engagement with pull apertures 52 of bolt 18 such that pull 76 and bolt 18 slide together. Posts 90 are retained for slidable disposition along pull grooves 80 via post barbs 92. The interlinking of pull 76 with bolt 18 provides a means for a user to retract bolt 18 from its engagement with keeper 22 by sliding pull 76 rearward along the path of pull grooves 80. As such, a comfortable finger pull on pull 76 provides positive feedback of the retraction or disengagement of bolt 18 with a snap feeling caused by engagement of catch 39 of trigger 16 with catch 50 of bolt 18. In turn, the front end portion 88 of pull 76 moves to a rearward position, exposing lock indicia 82. Lock indicia 82 can include the word “UNLOCKED”, or similar markings denoting disengagement or an unlocked state of bolt 18 from keeper 22. Because cover housing, and cover plate 74 are removable, end users or manufacturers can change the lock aesthetics with various cover shapes and components according to particular preferences.

Keeper 22 generally includes hook slots 94, bolt slot 95, fastening apertures 96 and ledge portion 97. Keeper 22 is disposable on top or recessed mounted window systems, as depicted in FIGS. 2-3. Hook slots 94 are arranged to receive and align hooks 68 of lock base 14 and bolt slot 95 is arranged to receive latch bolt 18, as shown in FIGS. 4-7. Lock housing 12 and keeper 22, and their respective components and structures, can be constructed of a variety materials, including plastics, metals, and other known materials.

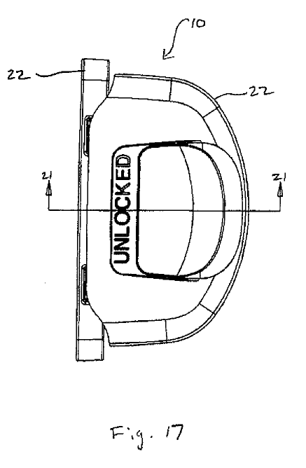

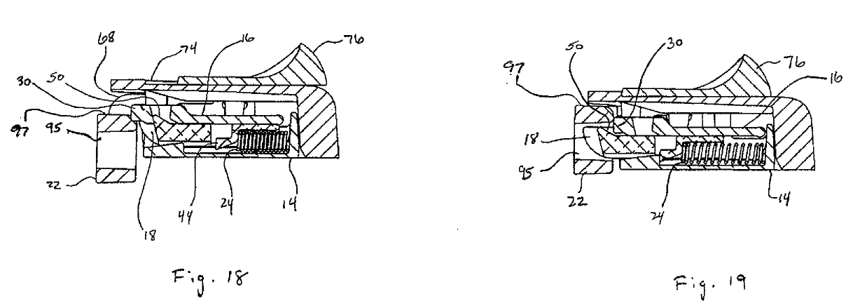

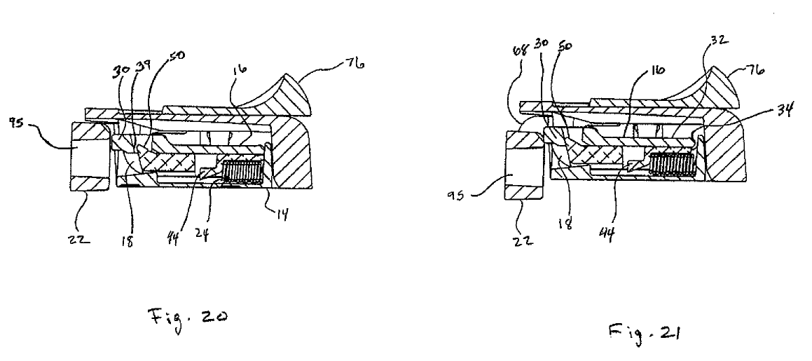

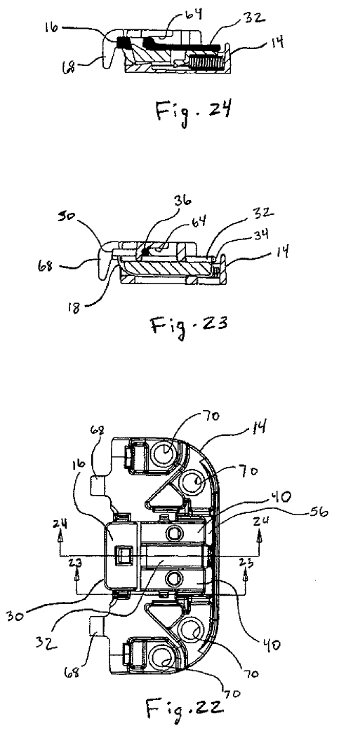

FIGS. 14-21 depict various operational configurations for the components of lock mechanism 10. In use, lock mechanism 10 is mounted on a window assembly 25 that can include sliding sash 26 and other sash 27. Lock housing 12 is mounted on sliding sash 26 opposite keeper 22 via fastening apertures 70, with keeper 22 mounted on stationary sash 27 via fastening apertures 96. When sliding sash 26 is open, lock housing 12 and keeper 22 are disengaged as shown in FIGS. 16 and 20. In this configuration, lock mechanism 10 is in the unlocked position, whereby pull 76 is pulled back such that bolt 18 is retracted back into the lock base 14 and out of bolt slot 95 of keeper 22. Accordingly, sliding sash 26 can be slid away from stationary sash 27 and hooks 68 of lock base 14 can disengage from hook slots 94 of keeper 22.

When the sliding sash 26 is moved into a closed position, lock housing 12 engages keeper 22, as depicted in FIGS. 14-15 and 18-19. In this position, bolt 18 is initially in the retracted position within lock base 14 and at least the front end portion 30 of trigger 16 extends out from front wall 72 of lock base 14. Trigger pivots 36 abut portions of respective base guides 64. In addition, bolt catch 50 is captured by trigger catch 39 and the trigger pivots 36 bear against base guides 64 to prevent the bolt 18 from advancing forward out of the lock base 14. Pivots 36, while seated within base guides 64, also provide trigger 16 a level of pivotability within the lock channel 56. As such, the force of the tail end of retracted bolt 18 against tail bulbs 34 biases the trigger catch 39 down onto bolt catch 50 to further assist in retaining bolt 18 in the retracted position.

As the front end portion or leading edge 30 of trigger 16 abuts or otherwise contacts top ledge 97 of keeper 22 (FIG. 18), biasing spring 24 propels bolt 18 forward into keeper 22. As a result, trigger 16 is retracted back a distance into lock base 14 and the leading edge 30 of trigger 16 can remained pressed against keeper 22, as shown in FIG. 19. The bolt 18 is able to advance into keeper 22 because as trigger 16 abuts keeper 22, trigger 16 pivots or shifts up until trigger catch 39 releases bolt catch 50, allowing biasing spring 24 to act on bolt 18. The front end portion or leading edge 42 of bolt 18 then engages bolt slot 95 of keeper 22. Bolt stop 44 abuts lock base stop 60 of lock base 14 to limit the distal extension of bolt 18 into bolt slot 95. The front end 42 of bolt 18 or a portion of bolt slot 95 can be radiused or chamfered to aid in proper coupling of the sashes, even in cases of misalignment. This locked configuration of lock housing 12 with keeper 22 is indicated by the pull 76 moving to the locked position, covering lock indicia 82 (FIG. 15).

To unlock the lock mechanism 10 when the sliding sash 26 is secured to the other sash 27, pull 76 is pulled rearward with respect to housing cover 74 using lip 86, as depicted in FIGS. 16-17 and 20-21. As pull 76 slides rearward, bolt 18 is pulled out of keeper 22 against the bias of spring 24 until bolt 18 is substantially within lock base 14. Specifically, the linking of pull 76 and bolt 18 causes bolt 18 to retreat as pull 76 is slid rearward. As bolt 18 retracts, trigger 16 also retracts until tail end 34 of trigger 16 hits rear wall 58 of the lock base, preventing trigger 16 from retracting further. Bolt 18, however, continues to be retracted further until trigger catch 39 captures bolt catch 50 to secure bolt 18 within the lock base 14. When bolt 18 is slid backward into the lock base 14, biasing spring 24 causes trigger 16 to slide forward upon clearing keeper 22 such that front end portion 30 of trigger 16 extends out from the front wall 72 of lock base 14. With bolt 18 in this position, sliding sash 26 may be slid along its track 28, and hooks 68 of lock base 14 disengage hook slots 94 of keeper 22, thereby opening the window. In this position, front end 88 of pull 76 exposes the lock indicia 82 provided on cover plate 74 (FIG. 17).

In another embodiment, as depicted in FIGS. 25-29, a lock mechanism 110 generally includes a lock housing 111 and a keeper 114. Lock housing 111 generally includes a lock base 112, trigger 115, bolt 116, housing cover 118, and handle 120. Lock base 112 generally includes front wall 122, rear wall 124, and top wall 126. Rear wall 124 defines lock aperture 128, trigger apertures 130, and cover hook apertures 132. Top wall 126 defines a central aperture 134.

Trigger 115 can include a pair of lobes 136 that are received within trigger apertures 130 of base 112. Twin lobes 136 provide a pair of triggering surfaces, which allows lock mechanism 110 to lock even in situations where window sashes are misaligned. A bolt aperture 138 having bolt guides 140 is defined through trigger 115. Trigger 115 rests within central aperture 134 of lock base 112 and is slidably disposable therein. Bottom surface 142 of trigger 115 is offset from bottom surface 144 of lock base 112, providing clearance for uneven mounting surfaces and allowing trigger 115 to slide forward and backward relative to lock base 112. Trigger 115 can be a single injection molded plastic part, which reduces the part count and costs of lock mechanism 110 and minimizes the force needed to activate the lock.

Bolt 116 has wings 146 extending laterally from each side, and is slidably disposable in bolt aperture 138 of trigger 115, with wings 146 resting along bolt guides 140. Bolt 116 includes a tapered leading edge 148. Biasing spring 150 is disposed between rear surface 152 of bolt 116 and inside surface 154 of front wall 122 to bias bolt 116 outwardly through lock aperture 128.

Housing cover 118 includes hooks 156 that engage apertures 132 of lock base 112. This allows cover 118 to be easily removed from lock mechanism 110. Handle 120 includes a grip 158 in its upper surface 160 that provides a means for sliding handle 120 between a locked position and an unlocked position. Post 162 extends downwardly from handle 120 and is flanked by a pair of guides 164. Handle 120 is slidably disposed on housing cover 118 with post 162 extending through slot 166 and guides 164 through guide slots 168. Post 162 engages bolt 116 so that bolt 116 and cover 118 slide together.

Keeper 114 includes hooks 170 that engage slots 172 in lock base 112 to secure keeper 114 to lock base 112. A bolt slot 174 is defined in keeper 114 to engage bolt 116 when lock mechanism 110 is in the locked position.

In use, lock mechanism 110 is mounted on a window assembly 25. Lock housing 111 is mounted on a sliding sash 26 opposite keeper 114 mounted on a stationary sash 27. When sliding sash 26 is open, lock housing 111 and keeper 114 are disengaged as shown in FIG. 26. Lock mechanism 110 is in the unlocked position, whereby handle 120 is slid away from housing cover 118 and bolt 116 is retracted into the lock housing 111, such that it does not project outwardly from lock aperture 128. Lobes 136 of trigger 115 project outwardly through trigger apertures 130 of lock base 112. In addition, various forms of lock indicia can be provided with housing cover 118 to indicate locked or unlocked states for the lock mechanism 110.

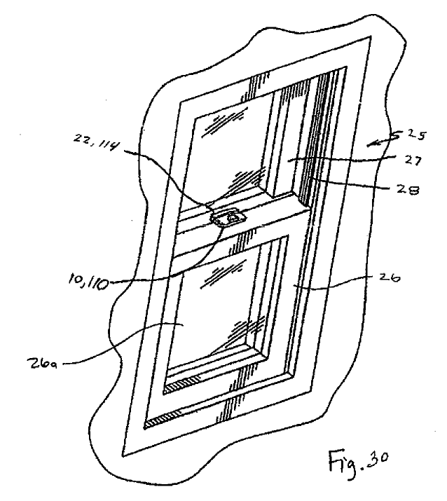

When the sliding sash 26 is closed, the lock housing 111 engages the keeper 114, as depicted in FIG. 27. The lobes 136 of trigger 115 are contacted by keeper 114, which allows biasing spring 160 to propel lock bolt 116 forwardly into keeper 114 and causes lobes 136 to retract into lock housing 111, as shown in FIG. 28. A leading edge 148 of bolt 116 engages bolt slot 174 of keeper 114. The upper surface 176 of bolt slot 174 can be radiused (FIG. 29) to aid in proper horizontal alignment of the sashes. This locked configuration of lock housing 111 and keeper 114 is indicated by the handle 120 moving to the locked position depicted in FIGS. 27-28.

To unlock the sliding sash 26, handle 120 is pulled way from housing cover 118 using grip 158. As handle 120 slides outwardly, bolt 116 is pulled out of keeper 114 against the bias of spring 160 until bolt 116 is substantially within base 112. With bolt 116 in this position, sliding sash 26 may be slid upwardly along track 28 to disengage keeper hooks 170 from slots 172 and open the window 26a. When bolt 116 is slid backward along bolt guides 140 of trigger 115, biasing spring 160 cause trigger 115 to slide forwardly such that lobes 136 extend outwardly through trigger aperture 130, allowing lock mechanism 110 to be relocked when the window is closed again.

It will be appreciated that the various components of lock mechanism 10, 110 may be made from any materials suitable in strength and durability. Lock base 14, 112 can be constructed from, for example, die-cast metal, while bolt 18, 116, housing cover 20, 118 and pull handle 76, 120 can be constructed of, for example, polymer blends. Moreover, it will be appreciated that lock mechanism 10, 110 may be used with any sliding window or opening, including without limitation, double hung windows and laterally sliding windows having one, two, or any other number of sliding sash assemblies.

The present invention may be embodied in other specific forms without departing from the spirit of the essential attributes thereof. Therefore, the described embodiments should be considered in all respects as illustrative and not restrictive with the appended claims defining the scope of the invention.

What is claimed is:

1. A lock mechanism for a sliding window, comprising:
a lock base defining a channel therein;
a latch bolt slidably disposed in the channel and selectively positionable between an extended bolt position wherein a portion of the latch bolt extends outwardly from the lock base and a retracted bolt position wherein the latch bolt is substantially contained in the lock base;
a biasing element operably coupled to the latch bolt and arranged to bias the latch bolt toward the extended bolt position;
a trigger operably coupled to the latch bolt and positionable between an extended trigger position wherein a portion of the trigger extends outwardly from the lock base when the latch bolt is in the retracted bolt position, and a retracted trigger position wherein at least a portion of the trigger is retracted into the lock base when the latch bolt is in the extended Dolt position; and
a keeper defining a bolt slot therein such that the latch bolt is extendable into the bolt slot when the latch bolt is in the extended bolt position.

2. The lock mechanism of claim 1, wherein the keeper further includes a ledge portion such that engagement of the portion of the trigger extending outwardly in the extended trigger position against the top ledge portion causes the latch bolt to advance to the extended bolt position under the bias of the biasing element, and the trigger retreats to the retracted trigger position.

3. The lock mechanism of claim 1, wherein the keeper further includes at least one hook slot adapted to receive at least one hook provided with the lock base to operably couple the keeper and the lock base when the latch bolt is extended into the bolt slot of the keeper.

4. The lock mechanism of claim 1, wherein the trigger further includes a trigger catch and the latch bolt further includes a bolt catch, with the trigger catch adapted to engage the bolt catch when the latch bolt is in the retracted bolt position.

5. The lock mechanism of claim 1, wherein the lock base further includes a base guide adapted to operably receive a portion of the trigger.

6. The lock mechanism of claim 5, wherein the portion of the trigger operably received by the base guide is at least one pivot portion adapted to operably slide within the base guide.

7. The lock mechanism of claim 1, wherein the biasing element is a spring.

8. The lock mechanism of claim 1, further including a cover having a pull that is operably coupled to the latch bolt such that retreat of the pull moves the latch bolt into the retracted bolt position.

9. The lock mechanism of claim 8, wherein the cover further includes lock indicia that indicates the lock mechanism is in an unlocked state when the latch bolt is in the retracted bolt position.

10. A sliding window comprising:
a stationary sash;
a sliding sash moveable between a window closed position wherein meeting rails of the stationary sash and the sliding sash are confronting each other and a window open position wherein the meeting rails of the stationary sash and the sliding sash are clear of each other; and
a locking mechanism disposed on the meeting rail of the sliding sash to selectively latch the stationary and sliding sashes together, the locking mechanism comprising:
a lock base defining a channel therein;
a latch bolt slidably disposed in the channel and selectively positionable between an extended bolt position wherein a portion of the latch bolt extends outwardly from the lock base and a retracted bolt position wherein the latch bolt is substantially contained in the lock base;
a biasing element operably coupled to the latch bolt and arranged to bias the latch bolt toward the extended bolt position;
a trigger operably coupled to the latch bolt and positionable between an extended trigger position wherein a portion of the trigger extends outwardly from the lock base when the latch bolt is in the retracted bolt position, and a retracted trigger position wherein at least a portion of the trigger is retracted into the lock base when the latch bolt is in the extended bolt position; and
a keeper disposed on the meeting rail of the stationary sash and defining a bolt slot therein such that the latch bolt is extendable into the bolt slot when the latch bolt is in the extended bolt position.

11. The sliding window of claim 10, wherein the keeper further includes a ledge portion such that engagement of the portion of the trigger extending outwardly in the extended trigger position against the ledge portion causes the latch bolt to advance to the extended bolt position and into the bolt slot, and the trigger retreats to the retracted trigger position.

12. The sliding window of claim 10, wherein the keeper further includes at least one hook slot adapted to receive at least one hook provided with the lock base to operably couple the keeper and the lock base when the latch bolt is extended into the bolt slot of the keeper in the window closed position.

13. The sliding window of claim 10, wherein the trigger further includes a trigger catch and the latch bolt further includes a bolt catch, with the trigger catch adapted to engage the bolt catch when the latch bolt is in the retracted bolt position.

14. The lock mechanism of claim 10, wherein the lock base further includes a base guide and the trigger further includes at least one pivot portion adapted to operably slide within the base guide.

15. The sliding window of claim 10, wherein the biasing element is a spring.

16. The sliding window of claim 10, further including a cover having a pull that is operably coupled to the latch bolt such that retreat of the pull moves the latch bolt into the retracted bolt position, permitting movement of the sliding sash to the window open position.

17. The sliding window of claim 16, wherein the cover further includes lock indicia that indicates the lock mechanism is in an unlocked state when the latch bolt is in the retracted bolt position.

18. A lock mechanism for a sliding window, comprising:
a lock base defining a channel therein;
means for latching disposed in the channel and selectively positionable between an extended position wherein a portion of the means for latching extends outside of the lock base and a retracted position wherein the means for latching is substantially contained in the lock base;
means for biasing operably coupled to and arranged to bias the means for latching toward the extended position;
means for triggering the means for biasing, wherein the means for triggering is operably coupled to the means for biasing such that when the means for latching is in the retracted position a portion of the means for triggering extends outwardly from the lock base; and
means for receiving the means for latching when the means for latching is in the extended position.

19. The lock mechanism of claim 18, wherein engagement of the portion of the means for triggering extending out of the lock base against a portion of the means for receiving causes the means for latching to advance to the extended position.

20. The lock mechanism of claim 18, wherein the means for triggering further includes means for catching the means for latching when the means for latching is in the retracted position.

21. The lock mechanism of claim 18, wherein the lock base further includes means for guiding the means for triggering within the lock base.

22. The lock mechanism of claim 18, wherein the means for biasing is a spring.

23. The lock mechanism of claim 18, further including means for covering the lock base having means for pulling the means for latching into the retracted position.

24. The lock mechanism of claim 23, wherein the means for covering further includes means for indicating when the lock mechanism is in an unlocked state when the means for latching is in the retracted position.
